(19) United States
(12) Patent Application Publication
(10) Pub. No.: US 2016/0257586 A1
(43) Pub. Date: Sep. 8, 2016

(54) WASTE DISTRIBUTOR SYSTEM AND APPARATUS

(71) Applicant: R. R. SHAAMSUNDARR, Irvine, CA (US)

(72) Inventor: R. R. SHAAMSUNDARR, Irvine, CA (US)

(21) Appl. No.: 14/636,603

(22) Filed: Mar. 3, 2015

(51) Int. Cl. C02F 3/00; C02F 3/28

(52) U.S. Cl. CPC C02F 3/006; C02F 3/28; C02F 2103/32

(57) ABSTRACT

A waste distribution device controllable by a user. Waste distributor device may be mechanically actuated, such as via a cable tension system or otherwise, and may allow a user to determine the channel in which waste will be deposited. Waste distribution device may be paired with a wastewater treatment system such as an anaerobic digester, and may be used in order to control how much waste is deposited in the wastewater treatment device and what contents are deposited. This may allow a user to avoid disrupting their wastewater treatment system by adding harmful chemicals or by preventing harmful byproducts or harmful concentrations thereof from being produced.

### BACKGROUND

Anaerobic digesters are a feature of many wastewater treatment facilities throughout the United States. They are generally used to break down sewage and, increasingly, food waste; this reduces the amount of material that must be treated and disposed of by other means, and produces potentially useful biogas in the process. Because anaerobic digesters tend to reduce ecological impact, produce renewable energy, and reduce costs for wastewater treatment facilities, they have seen increasing popularity and use in recent years.

However, some obstacles to their broader use remain. The first is that many of the potential byproducts of anaerobic digestion processes, such as hydrogen sulfide gas, can be toxic to people or corrosive to digester equipment. The second is that the digester bacteria themselves are environmentally sensitive; a digester environment must be kept within a certain narrow pH range near pH neutral (generally a range between about 6.8 to 7.2 is desirable) and kept free of harmful chemicals, including oxygen and toxic byproducts of the anaerobic digestion process itself, to avoid killing the bacteria driving the digestion process. These problems with anaerobic digesters—their potential hazards, and the need to closely regulate their internal environment—have limited the extent to which typical consumers have been able to make use of them, and in turn limited the extent to which typical consumers can reap their benefits. A system by which consumers and others may control the disposition of their wastewater, and thereby better regulate the disposition of that wastewater into sensitive subsystems like anaerobic digesters, offers numerous advantages.

### SUMMARY

According to one exemplary embodiment, a waste distribution device may be described. The waste distribution device may consist of a distributor and a control, and may be paired with a wastewater treatment system and a waste disposal channel. A user may be able to operate the control to select between the two, feeding wastewater into the treatment system or funneling it away from the device. The waste distribution device may be mechanically actuated, such as via a cable tension system or otherwise.

### BRIEF DESCRIPTION OF THE FIGURES

FIG. 1 is an exemplary diagram showing a cable-operated actuator and waste distribution device.

FIG. 1A is an expanded view of an exemplary diagram of an anaerobic digester system used in an exemplary waste distribution device.

FIG. 2 is an exemplary diagram of a cable-actuated waste distributor.

FIG. 3 is an exemplary diagram of a cable-actuating dial control mechanism for a waste distributor.

FIG. 4 is an exemplary diagram of a cable-actuating lever control mechanism for a waste distributor.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

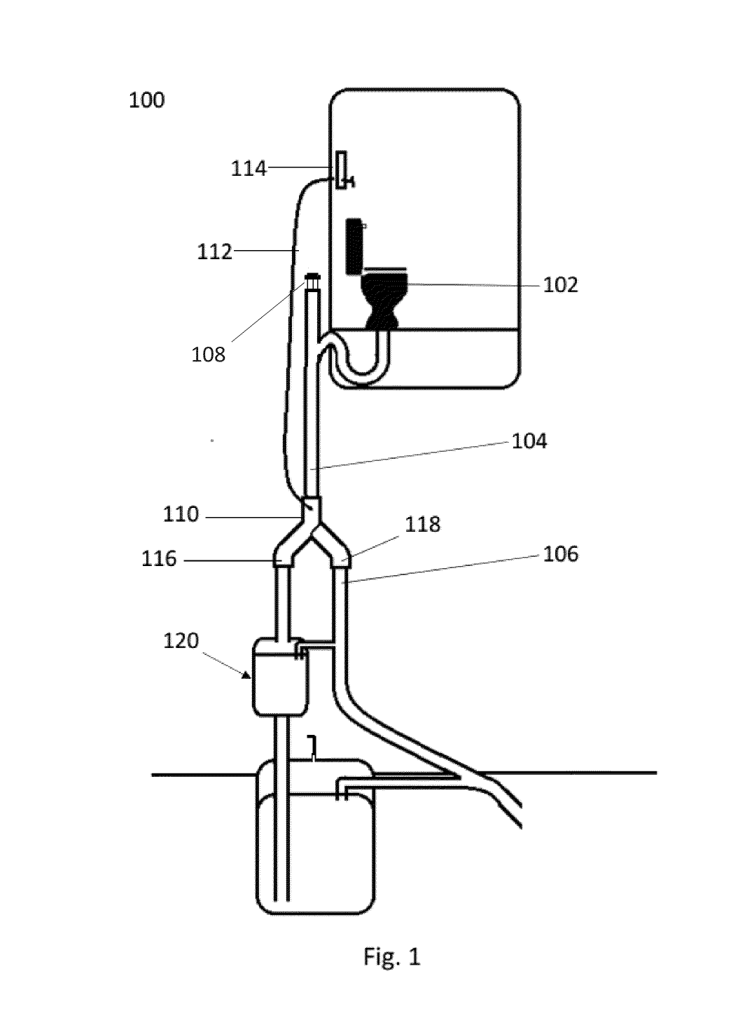

Referring now to exemplary FIG. 1, a cable-actuated waste distribution system 100 may be described. A sewage or wastewater source 102, such as a toilet, sink, dishwasher, or other household fixture, may be connected to a sewer pipe having an upper portion 104 and a lower portion 106. Sewer pipe 104, 106 may also have or be connected to a ventilator pipe 108, or alternatively may be connected to another ventilation or aeration device or several such devices. According to one exemplary embodiment, ventilator pipe 108 may be operationally connected to the upper portion 104 of the sewer pipe and may lead directly outside.

A cable-actuated waste distributor (hereinafter “distributor”) 110 may be placed in series with the upper 104 and lower 106 portions of the sewer pipe, joining the two to each other. The distributor 110 may be controlled by a user via a control cable 112. According to an exemplary embodiment, control cable 112 may be constructed from steel wire, and may allow a user to exercise control over the distributor 110 by way of a tensile force. According to other exemplary embodiments, control cable 112 may be constructed from another material or combination of materials, such as another metal or metal alloy or a polymer. According to still other exemplary embodiments, control cable 112 may allow a user to exercise control over the distributor 110 in an alternative manner other than by application of a tensile force, such as pneumatically, hydrostatically, via an electrical signal, or in any other manner desired.

A user may be able to exercise control over the control cable 112 via a control mechanism 114. Control mechanism 114 may be located for easy user access; according to an exemplary embodiment, control mechanism 114 may be mounted on the wall of a bathroom or near another sewage or wastewater source 102. Alternatively, control mechanism 114 may be located elsewhere, as desired. According to an alternative embodiment, multiple control mechanisms 114 or a distributed control mechanism 114 having multiple control cables 112 may also be envisioned. Control mechanism 114 may employ a dial, switch, lever, or another mechanical or non-mechanical device or devices compatible with the control cable 112; for example, a pneumatic control mechanism 114 may be employed in conjunction with a pneumatic control cable 112. For example, a mechanical control mechanism 114 such as a dial or lever may be employed, and may allow a user to control the position of the distributor 110 by applying varying levels of mechanical tension to the control cable 112.

According to some exemplary embodiments, control mechanism 114 may be paired with a display indicating certain diagnostic or sensor information from within the remainder of the system, for example sensor information displaying the remaining empty volume in the system, its pH, the concentrations of particular products of the treatment process, or any other desirable information. This may aid a user's decision-making process; for example, if the system pH is too far away from neutral, a user may flush additional water into the system to prevent damage or harm to pH-sensitive components, organisms, or other elements of the system. According to other embodiments, such information may be available on another part of the device, may be available remotely, or as desired.

Distributor 110 may divide or fork into two or more outlets 116, 118, each connected to a different outflow pathway. According to an exemplary embodiment, a first outlet 116 may be connected to and may disgorge its contents into a wastewater treatment or retention system 120 (hereinafter “wastewater treatment system”), such as an anaerobic digester system, septic tank, or similar system. A second outlet 118 may be connected to a sewer pipe or other waste disposal channel (“sewer pipe”) 106, which may allow a user to disgorge the contents of a wastewater source 102 directly into the sewer, allowing them to bypass the wastewater treatment system 120 entirely. This may allow a user to disgorge inorganic toxic cleaning agents or other potentially harmful or contaminating contents directly into the sewer instead of into the wastewater treatment system 120, and in doing so avoid contaminating or damaging the wastewater treatment system 120 via the introduction of said contents.

Turning now to exemplary FIG. 1A, an expanded view of an exemplary wastewater treatment system 120 that may be paired with a distributor 110 may be shown and described. In an exemplary embodiment, the wastewater treatment system 120 may be an anaerobic digester. Distributor outlet 116 may be connected to a digester pipe 122 that can lead downward into the digester. In an exemplary embodiment, digester pipe 122 may be vertical or substantially vertical, but may be sloped, inclined, or even horizontal and may be connected with a pump or pumping apparatus, as desired. Digester pipe 122 may be connected with a first tank 124, for example a waste dissolver and/or dispenser tank (“water dissolver tank”); the first tank 124 may be kept filled with water, with a pre-treatment bath, with a quantity of wastewater, or with other contents, as desired. According to an exemplary embodiment, the first tank 124 may be located above ground for ease of access, maintenance, and replacement, but may also be placed at ground level or below ground depending on factors like the size or weight of the first tank 124 and the requirements of the customer.

The first tank 124 may have an overflow pipe 126 that connects the first tank 124 to an adjoining sewer pipe or an alternative storage or disposal system 106 (hereinafter “sewer pipe”). The overflow pipe 126 may have a siphon such that excess material above a certain height in the first tank 124 may be drawn into the adjoining sewer pipe 106. The overflow pipe 126 may employ filtering, for example to ensure that solid waste remains within the first tank 124 or that treatment chemicals are not expelled to the environment, or may be directly open to the sewer pipe 106.

The first tank 124 may also have a dispenser pipe 128 that leads into a second tank 130. According to one exemplary embodiment, second tank 130 may be a treatment tank, and may, for example, contain anaerobic bacteria for use in an anaerobic digestion wastewater treatment process. Alternatively, second tank 130 may be used for chemical treatment of wastewater and may contain, for example, a chemical treatment solution. According to an exemplary embodiment, dispenser pipe 128 may be used to control the dispensation of wastewater or of specific constituents of the wastewater, such as solid or organic waste, into the second tank 130. This may prevent excessive dispensation or “over-feeding” of solid or organic waste into the second tank 130, which may allow control over the rate at which it is broken down and may prevent the buildup of toxic chemical byproducts of the anaerobic digestion process.

The combination of the dispenser pipe 128 and the first tank 124 may also be used in order to avoid or reduce clogging or debris buildup between distributor outlet 116 and the second tank 130. According to an exemplary embodiment, solid waste may be dissolved or pre-treated in the first tank 124, for example by dissolving it in water, and gradually dispersed into the second tank 130 in liquid or slurry form via the dispenser pipe 128. According to such an embodiment, this may dilute the solid waste and de-congest the flow of solid waste into the second tank 130, thereby reducing the potential for the inlet to the second tank 130 to be blocked by a clog. Dispersal or the rate of dispersal of solid waste from the dispenser pipe 128 may be controllable; for example, a mesh filter may be placed in series with the dispenser pipe 128 to prevent solid waste of above a certain size from entering into the second tank 130, or the aperture size of the dispenser pipe 128 may be restricted or widened in order to allow less or more material through. Other alternative flow controllers may also be envisioned.

In the event that the inlet to the second tank 130 becomes restricted or clogged, the overflow pipe 126 may act as a temporary channel for solid waste and any other contents of the first tank 124 to flow into the sewer pipe 106. Under such a condition, distributor 110 may be configured to divert all incoming waste through its sewer-adjoining outlet 118 and into the sewer pipe 106. According to some exemplary embodiments, distributor 110 and/or control mechanism 114 may be configured to do this automatically; according to other embodiments, diverting the flow may require user intervention. According to the second set of embodiments, the presence of a clog or other flow restriction within the wastewater treatment system 120 may be indicated by diagnostic and/or sensor information.

A user may be able to clear a restriction or clog by operation of internal mechanisms, such as a manual rotor mechanism or a similar tool, by operation of a pressurized air or water supply, or by another desired means. Alternatively, such internal mechanisms as exist may be autonomously operable by the action of the wastewater treatment system itself 120, for example by the operation of a processor and/or memory operationally connected to any diagnostic devices and/or sensors. According to other embodiments, a user may be required to manually clear the clog, for example by partially disassembling the wastewater treatment system 120 and using an appropriate plumbing tool to clear the clogged component.

According to some exemplary embodiments, the first tank 124 may contain additional mechanisms to facilitate the dissolution of solid waste. Such mechanisms may include, for example, a mechanical incinerator, an agitating device such as a rotor or rotor-pulse device, a crusher, grinder, or shredder, or another desired mechanical decomposition device. Such mechanisms may be separately controllable or may operate periodically or constantly, as desired. Mechanical decomposition device may be motorized; alternatively, it may be wholly or partially manually operable, for example being a manually-turned crank, rotor, or screw, or may be operated as desired. A chemical treatment or an electrical treatment (such as catalytic ionic-impact decomposition) may be used instead of or as a supplement to a mechanical decomposition system, as desired. According to an exemplary embodiment, a multiple-stage decomposition process may be used; for example, the waste may be broken down by a chemical means, and then further treated to prepare the waste for dispersal into the second tank 130.

Second tank 130 may also dispense excess material to an adjoining sewer pipe 106. In this case, dispensation may take place via an overflow pipe configured to pass slurry (“slurry pipe”) 132 or through another manner, for example via another form of pipe or via a direct connection. According to an exemplary embodiment, slurry pipe 132 may be substantially thicker than the overflow pipe 126 used to remove excess material from the first tank 124, may be unobstructed with no intermediate filtering, and may have an internal composition suited to resist abrasion and corrosion from any solid matter exiting the second tank 130 via the slurry pipe 132. According to an exemplary embodiment, a polymer such as poly-vinyl chloride or high-density polyethylene may be used to construct or line the slurry pipe. However, it may be appreciated that, in alternative exemplary embodiments, any suitable material may be used instead.

Second tank 130 may also allow for removal of and capture of any products of the treatment process, for example any biogas produced by an anaerobic digester. Removal of said products may take place through a dedicated outlet, such as a biogas outlet 134, or may take place through another channel or as desired. Biogas outlet 134 may be operationally connected to a storage tank or other storage mechanism, to a power generation system, to one or more household appliances (e.g. a gas range or stove), or to any other system desired. Alternatively, if desired, biogas may be directly output to the environment.

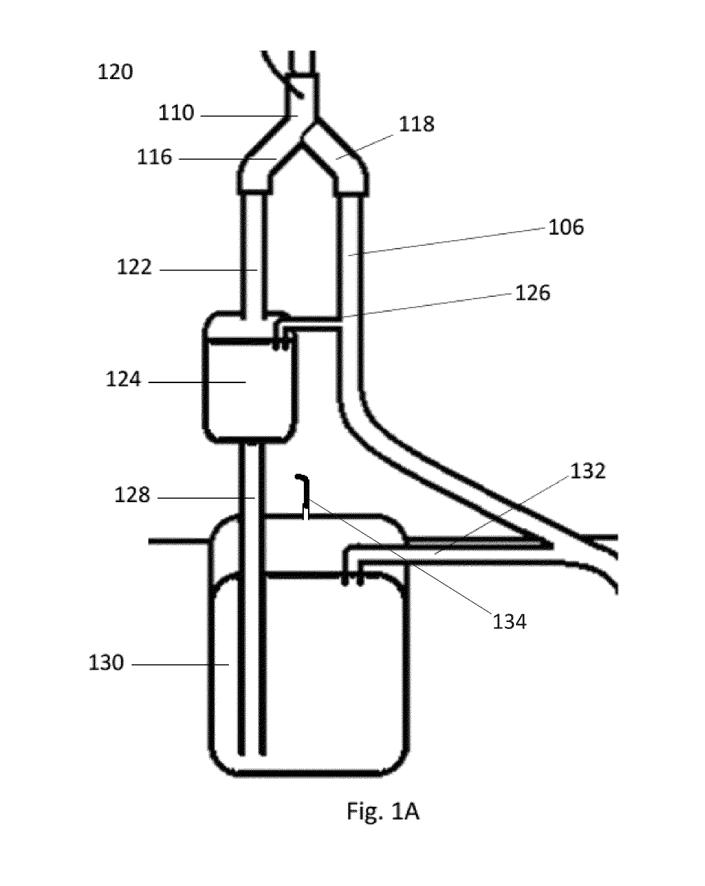

Referring to exemplary FIG. 2, a cable-actuated waste distributor 200 may be described. According to an exemplary embodiment, distributor 200 may be constructed from poly-vinyl chloride, but may also be constructed from any other suitable material, such as the same material used to construct any adjoining pipes. Distributor 200 may have an inlet pathway 220, a multiplicity of outlet pathways 216, 218, connection sites 222 at which the distributor 200 may be connected to other pipes or components, and may have a valve, stopper, or other flow obstructer or combination of flow obstructers 202 (which may generally be referred to by the term “valve”) sized to obstruct one of the outlet pathways 216, 218 when fully closed or fully open. According to an exemplary embodiment, a flap-style selector valve (“flap valve”) 202 may be used. Flap valve 202 may rotate on a bolt pivot 206, and may be linked to a pulley rotor 204 that also rotates about the bolt pivot 206. Pulley rotor may be connected to a control cable 212, which may supply rotary motion to the pulley rotor 204 and thus the flap valve 202 by the application of a tensile force on the control cable 212, or, alternatively, by the reduction of an existing tensile force on the control cable 212.

According to one exemplary embodiment, distributor 200 may have irregular internal geometry 208 suited to create a better seal between the flap valve 202 and the internal wall of the distributor 200 when the flap valve 202 is in position to seal either the digester supply pathway 216 or the sewer outlet pathway 218; this irregular internal geometry 208 may include a recess into which the flap valve 202 may fit, an elastic seal held in place on the inner wall of the distributor 200, another manner of securing a seal or a combination of multiple devices, or other geometry, as desired. According to an alternative exemplary embodiment, irregular internal geometry 208 may be optional, and the flap valve 202 may be lipped with an elastic seal or composed of an elastic material to seal the outlet pathways 216, 218. According to another exemplary embodiment, a different form of valve, such as a butterfly valve, or a different stopper or other flow obstructer may be used instead.

Still referring to exemplary FIG. 2, the pulley rotor 204 may be linked to a spring release 210 that may apply a force to the pulley rotor 204 tending to rotate it in a certain direction. This may be paired with the control cable 212 such that if a tensile force is applied to the control cable 212, the pulley rotor 204 may be caused to rotate in one direction, whereas if no tensile force is applied to the control cable 212, the pulley rotor 204 may be caused by the force applied by the spring release 210 to rotate in the other direction. According to an exemplary embodiment, the force applied on the pulley rotor 204 by the spring release 210 may be sufficient to tightly or securely seal one of the outlet pathways 216, 218. Spring release 210 may be connected to the pulley rotor 204 by a linking connector. For example, a cable fastener clip may be directly connected to the pulley rotor 204, or may be connected as desired.

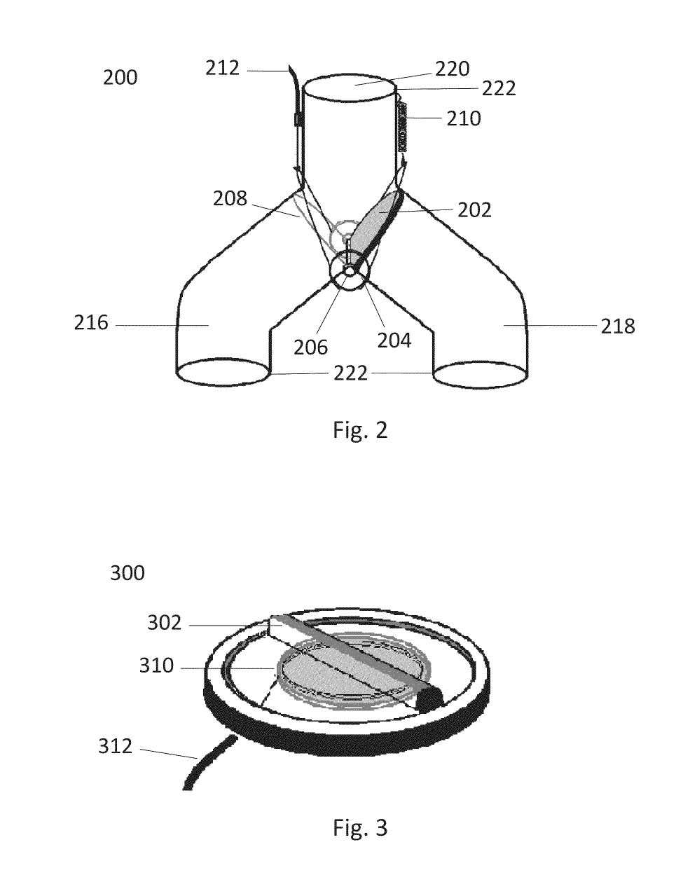

Referring now to exemplary FIG. 3, an embodiment of a cable-actuating dial control mechanism 300 may be described. A dial selector 302 may control the position of a spring release and locking mechanism 310 (“spring release”), which may in turn affect the amount of tension that is applied to a control cable 312 extending from the dial control mechanism 300. Turning the dial selector 302 one way may increase the amount of tension applied to the control cable 312, which in turn may change the position of a pulley rotor operationally linked to the control cable 312. Turning the dial selector 302 the other way may decrease the amount of tension applied, which in turn may cause the linked control cable 312 to slacken, decreasing the force applied to an operationally linked pulley rotor and causing a spring release operationally linked to the same pulley rotor to tend to pull it in the other direction.

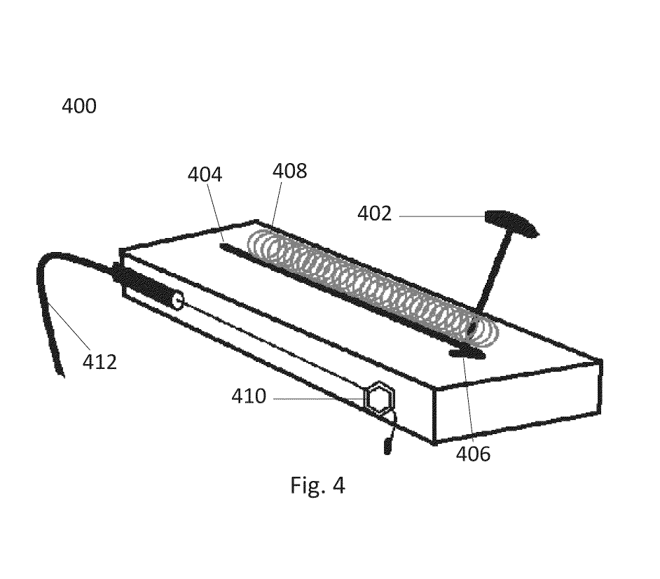

Referring now to exemplary FIG. 4, an embodiment of a cable-actuating lever control mechanism 400 may be described. The lever control 400 may be operated with or by control knob 402, which may sit in a slot 404 and have a locking groove 406 on one end. The lever control mechanism 400 may also have a lever return spring 408 that may apply a force to the control knob 402 in the direction of the slot 404 opposite the locking groove 406. According to other exemplary embodiments, an alternative restoring mechanism other than a spring 408 may be used, or the lever control 400 may have a multiplicity of locking grooves 406 corresponding to appropriate positions, or another configuration may be adopted as desired.

A cable tensioner 410 may be operationally linked to both the control knob 402 and a control cable 412. Operation of the control knob 402 may cause the cable tensioner 410 to exert lesser or greater amounts of force on the control cable 412, which may in turn cause the control cable 412 to exert lesser or greater amounts of force on an operationally linked pulley rotor.

An exemplary method for using a cable actuated waste distributor system may also be described. A user may first examine the wastewater to be treated, and may identify whether or not any of the constituent parts of the wastewater are harmful to at least one of a wastewater treatment system, structures or persons when processed by the wastewater treatment system. The user may then select, based on the composition of the wastewater to be treated, whether the wastewater should be dispensed into a channel leading to a wastewater treatment system, or should be dispensed into another channel not leading to a wastewater treatment system.

For example, if the wastewater treatment system makes use of an anaerobic digester, the user may select whether or not to dispense wastewater based on such information as the toxicity of the wastewater to the anaerobic bacteria, the potential hazardousness of the products of anaerobic digestion of the wastewater, the current state of the internal environment of the anaerobic digester, or any other information, as desired. A user may also select whether or not to dispense wastewater into an anaerobic digester system based on information like its size, capacity, anaerobic digestion rate, the amount of wastewater to be dispensed, or other such information, as desired. According to one exemplary embodiment, a user may opt to turn the valve to load or feed the digester only at designated times, such as on every alternate day or according to another timeframe. More limited dispersal of the wastewater may reduce the risk of the system developing a clog or a related problem and may ensure that the system operates optimally.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

1. A wastewater distribution device, comprising:
a distributor, the distributor having a valve by which wastewater is diverted into one or more outflow channels, wherein the distributor has an irregular internal geometry at each of the one or more outflow channels; and
a control coupled to the distributor valve such that operation of the control modifies the position of the distributor valve, wherein at least one spring release biases the distributor valve against the irregular internal geometry of a first outflow channel of the one or more outflow channels, and operation of the control works against a force of the at least one spring release to bias the distributor valve against the irregular internal geometry of at least one second outflow channel of the one or more outflow channels;
a wastewater treatment system coupled to the at least one second outflow channel of the distributor and configured to receive wastewater; and
a waste disposal channel coupled to the first outflow channel of the distributor and configured to receive wastewater.

2. The wastewater distribution device of claim 1, wherein the control is coupled to the distributor valve by at least one cable.

3. The wastewater distribution device of claim 2, wherein the control operates to modify a force applied to the distributor valve by the at least one cable.

4. The wastewater distribution device of claim 1, wherein the wastewater treatment system is an anaerobic digester.

5. The wastewater distribution device of claim 1, wherein the wastewater treatment system comprises multiple tanks.

6. The wastewater distribution device of claim 5, wherein at least one first tank is connected to at least one second tank, and wherein the at least one first tank is configured to dispense material into the at least one second tank at a controlled rate.

7. The wastewater distribution device of claim 1, wherein the wastewater treatment system is coupled to the waste disposal channel such that waste is dispensed from the wastewater treatment system directly into the waste disposal channel.

8. The wastewater distribution device of claim 7, wherein the wastewater treatment system is coupled to the waste disposal channel by an overflow pipe.

9. The wastewater distribution device of claim 8, wherein the overflow pipe is linked to a siphon within the wastewater treatment system.

10. The wastewater distribution device of claim 1, wherein the control is a dial.

11. The wastewater distribution device of claim 1, wherein the control is a lever.

12. A wastewater treatment system, comprising:
an inlet pipe;
a waste dissolver tank;
a dispenser pipe; and
a treatment tank;
wherein the digester pipe links a wastewater inlet and the waste dissolver tank, the dispenser pipe links the water dissolver tank and the treatment tank, and the dispenser pipe further dispenses wastewater into the treatment tank.

13. The wastewater treatment system of claim 12, wherein the inlet pipe, the waste dissolver tank, the dispenser pipe, and the treatment tank are vertically aligned.

14. The wastewater treatment system of claim 12, wherein the treatment tank is an anaerobic digester.

15. The wastewater treatment system of claim 12, wherein the wastewater treatment system is operationally linked to a waste disposal channel such that waste is dispensed from the wastewater treatment system directly into the waste disposal channel.

16. The wastewater treatment system of claim 15, wherein the operational linkage of the wastewater treatment system to the waste disposal channel is by at least one overflow pipe.

17. The wastewater treatment system of claim 15, wherein the operational linkage of the wastewater treatment system to the waste disposal channel includes a siphon.
